(19) United States
(12) Patent Application Publication
(10) Pub. No.: US 2009/0176018 A1
(43) Pub. Date: Jul. 9, 2009

(54) NANO/MICRO-TEXTURED SURFACES AND METHODS OF MAKING SAME BY ALUMINUM-INDUCED CRYSTALLIZATION OF AMORPHOUS SILICON

(76) Inventors: Min Zou, Fayetteville, AR (US); Hengyu Wang, Fayetteville, AR (US)

Correspondence Address: Min Zou, 4407 W Trillium Lane, Fayetteville, AR, 72704, US

(21) Appl. No.: 12/319,579

(22) Filed: Jan. 9, 2009

Related U.S. Application Data
(60) Provisional application No. 61/020,014, filed on Jan. 9, 2008.

(51) Int. Cl. B05D 5/02

(52) U.S. Cl. 427/258

(57) ABSTRACT

The present invention discloses a method of surface texturing at nano/micro-scale by aluminum-induced rapid crystallization of amorphous silicon for controlling the wettability of a surface, enhancing cell attachment to a surface, and promoting cell growth on a surface. The present invention can be used in a variety of applications, such as producing superhydrophobic or superhydrophilic surfaces for medical devices, microelectromechanical systems, and microfluidic channels.

### CROSS-REFERENCE TO RELATED PATENT APPLICATION

This application claim priority to U.S. Provisional Patent Application Ser. No. 61/020,014, filed Jan. 9, 2008, entitled “NANO/MICRO-TEXTURED SURFACES AND METHODS OF MAKING SAME BY ALUMINUM-INDUCED CRYSTALLIZATION OF AMORPHOUS SILICON” by Min Zou and Hengyu Wang.

### FIELD OF THE INVENTION

The present invention relates primarily to a method of surface texturing and its applications, and more specifically, to a method of surface texturing at nano-/micro-scale by aluminum-induced rapid crystallization of amorphous silicon for uses in controlling surface wetting properties, promoting cell attachment on a surface, and promoting cell growth on a surface.

### BACKGROUND OF THE INVENTION

Surface textures have wide applications: they can be used to control the wetting properties of a surface and to promote cell attachment and growth on a surface [1-4].

Superhydrophobicity and superhydrophilicity are two valuable wetting properties of a surface. A superhydrophobic surface is defined as a surface with water contact angle (WCA) of more than 150°, while the superhydrophilic surface is a surface with WCA of less than 5° within 1 second after a water droplet drops on the surface.

Superhydrophobic surfaces have attracted great attention in the past decade due to their important applications in surface self-cleaning, stiction prevention and drag reduction. Extensive studies show that a superhydrophobic surface has to have surface textures. A typical example of superhydrophobic surface is a lotus leaf surface that is textured with micro-sized “bumps” with nano-sized particles on the “bumps”. With a hydrophobic wax-like coating, the micro- and nano-textured surface becomes superhydrophobic.

Superhydrophilic textured surfaces have also attracted much attention due to their wide range of applications. For example, superhydrophilic surface is anti-foggy. In winters, window-glasses of vehicles and lenses of eyeglasses can become foggy because the water vapor in air condenses on these surfaces. Similarly, endoscopic lenses and the mirrors used by dentists can be fogged by the condensation of the hot moisture in patients on the cold surfaces. Foggy surfaces can create safety issues in many cases. The safety of a driver can be undermined if the windshield of a vehicle becomes blurred, and an operation may be compromised if an endoscopic lens becomes foggy.

In the biomedical field, textured surfaces also have important applications. Nano- or micro-scale textures can promote cell attachment to a surface and cell growth on a surface. For example, textured surfaces are beneficial to osteoblast response and bone growth for artificial joints. Textured surfaces can also improve the attachment of living cells on glass slides, which makes cell observation and analysis easy in research on living cells under microscopes.

Given the importance of micro- and nano-textured surfaces, various surface texturing methods have been investigated and developed. For example, aligned carbon nanotubes, electroless etching, electroplating, oxygen plasma etching, soft-lithography imprinting, deep reactive ion etching have been used to texture surfaces [5-7]. However, these approaches are either too complicated, or too expensive, or not being able to produce a textured surface with stable wettability.

In view of the above problems, there is a need for developing a simple and low cost method that can produce nano-/micro-textured surfaces for controlling surface wetting properties, promoting cell attachment to a surface, and enhancing cell growth on a surface.

### SUMMARY OF THE INVENTION

The present invention relates to a method of surface texturing at nano- and micro-scale by aluminum-induced rapid crystallization (AIRC) of amorphous silicon (a-Si) for controlling the wettability of a surface, enhancing cell attachment to a surface, and promoting cell growth on a surface.

The method comprises the steps of: (a) forming a layer of a-Si on a surface of a substrate; (b) exposing the a-Si to air to form native silicon oxide buffer layer on the top of the a-Si film; (c) forming a layer of aluminum (Al) on the layer of native silicon oxide to form a sample; (d) applying heat treatment to the sample; and (e) removing excessive Al from the sample after the heat treatment.

The native silicon oxide buffer layer between the a-Si and the Al is not critical to the present invention. The buffer layer can be silicon oxide, silicon nitride, etc. The a-Si and Al layers can also contact each other directly without a buffer layer. In addition, the order of forming a-Si and Al layers is not critical. An a-Si layer can be formed before or after the formation of an Al layer. Al and a-Si can also be deposited on a substrate simultaneously to form an Al and a-Si mixed layer. The number of a-Si or Al layers is not critical to the present invention either. The most important concept of present invention is using Al to induce the crystallization of a-Si to create a nano/micro-textured surface for use in controlling surface wettability and promote cell attachment and growth on a surface.

Although aluminum-induced crystallization of a-Si has been extensively studied for many years, the focus has been on growing polycrystalline silicon films with large grains at low temperatures for the applications in the fields of electronics, photovaltics, and optoelectronics [8-11]. The present invention discloses, for the first time, the use of aluminum-induced crystallization of a-Si to produce nano/micro-textured surfaces for the applications in controlling the wetting properties of a surface, enhancing cell attachment to a surface, and promoting cell growth on a surface.

The present invention has the following advantages:
1. The wettability of the nano-/micro-textured surfaces produced by the present invention is stable, which is critical for real world applications.
2. The textures are transparent, which is particularly important for producing textures on glass slides for laboratory analysis of living cells attached on the glass slides.
3. The textures produced by the present invention are bio-compatible, which is critical for bio-related applications.
4. The equipment and materials used to produce surface textures are commonly used in semiconductor industry.

### BRIEF DESCRIPTION OF THE DRAWINGS

The accompany drawings illustrate one or more embodiments of the present invention and serve to explain the principles of the present invention.

FIG. 1 is a schematic drawing of one embodiment showing the process steps for producing nano/micro-textured surface using the AIRC of a-Si technique according to the present invention.

FIG. 2 is a scanning electron microscopy (SEM) image showing the surface topography of a textured surface created by the AIRC of a-Si technique according to the present invention.

FIG. 3 is an energy dispersive X-ray spectroscopy (EDS) spectrum showing the chemical elements of the textured surface created by the AIRC of a-Si technique according to the present invention.

FIG. 4 is an X-ray diffraction (XRD) spectrum showing the crystalline orientation of the textures on the textured surface created by the AIRC of a-Si technique according to the present invention.

FIG. 5 is an electron diffraction pattern taken from a silicon crystallite on the textured surface.

FIG. 6 is a schematic drawing of another embodiment showing the process steps for producing nano/micro-textured surface using the AIRC of a-Si technique according to the present invention.

FIG. 7 is a schematic drawing of yet another embodiment showing the process steps for producing nano/micro-textured surface using the AIRC of a-Si technique according to the present invention.

FIG. 8 is a schematic drawing showing sample structures illustrating how to produce a superhydrophobic surface using the AIRC of a-Si technique according to the present invention.

FIG. 9 is an SEM image showing the surface topography of a textured surface created by the AIRC of a-Si technique.

FIG. 10 is an optical image showing superhydrophobicity of a textured surface.

FIG. 11 is a schematic drawing showing sample structures illustrating how to produce a superhydrophilic surface using the AIRC of a-Si technique according to the present invention.

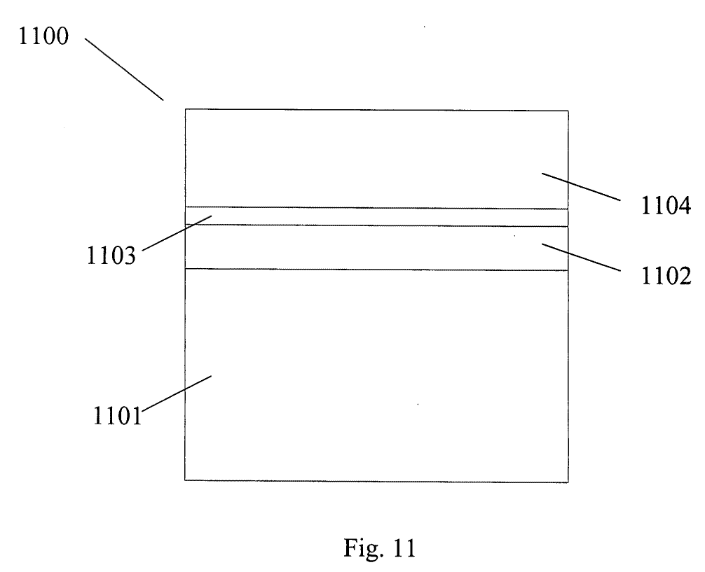

FIG. 12 is a SEM image showing surface topography of a textured surface created by the AIRC of a-Si technique.

FIG. 13 is an optical image showing superhydrophilicity of a textured surface.

FIG. 14 is a schematic drawing showing sample structures illustrating how to produce a textured surface to enhance cell attachment using the AIRC of a-Si technique according to the present invention.

FIG. 15 is an SEM image showing the surface topography of a textured surface created by the AIRC of a-Si technique.

FIG. 16 is a high magnification optical image showing cell attachment on surfaces using the present invention.

### DETAILED DESCRIPTION OF THE INVENTION

The present invention is more particularly described in the following embodiments and examples which are intended for illustrative purpose only since numerous modifications and variations will be apparent to those skilled in the art. The detailed description of the present invention is in no way intended to limit the invention, its application, or uses.

### First Embodiment

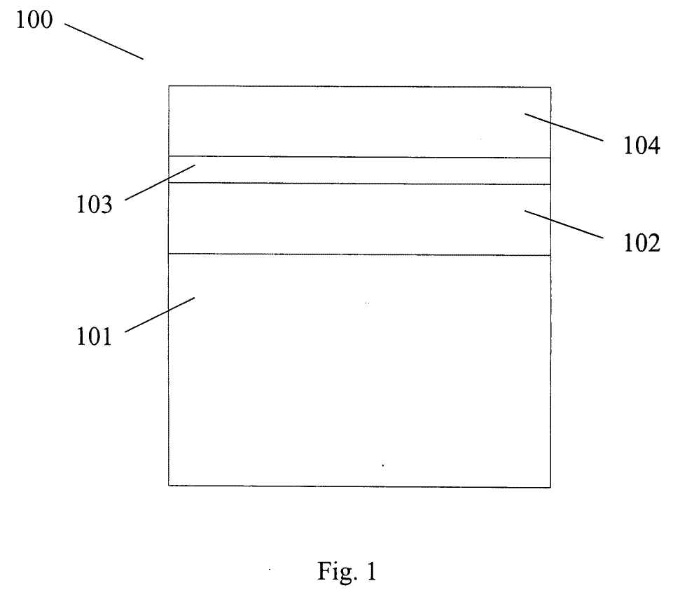

Referring to FIG. 1, a plasma-enhanced chemical vapor deposition (PECVD) system is used to deposit a layer of a-Si 102 on a silicon oxide coated silicon (100) wafer 101 to form a sample. After the deposition of a-Si 102, the sample is removed from the PECVD system and exposed to air to form a thin layer of native oxide 103 on top of the a-Si 102. The sample is then transferred to an evaporator for thermal deposition of a layer of Al 104 on top of the native silicon oxide 103 to form a multi-layer structure 100. The structure 100 is annealed in air in a conventional furnace. After annealing, the excessive Al on structure 100 is removed by wet selective etching, resulting in nano/micro-textured surfaces.

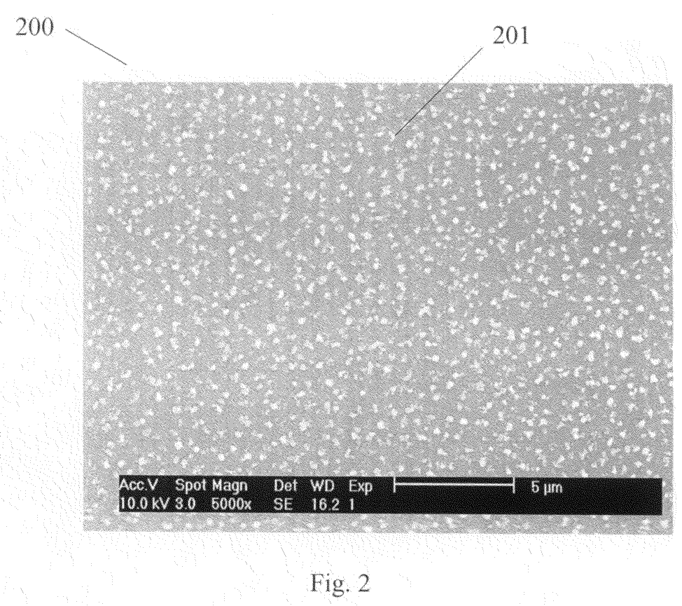

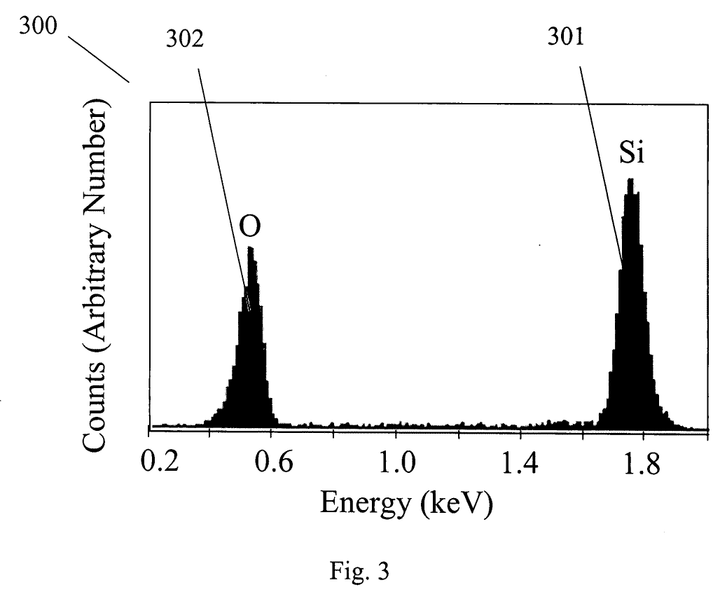

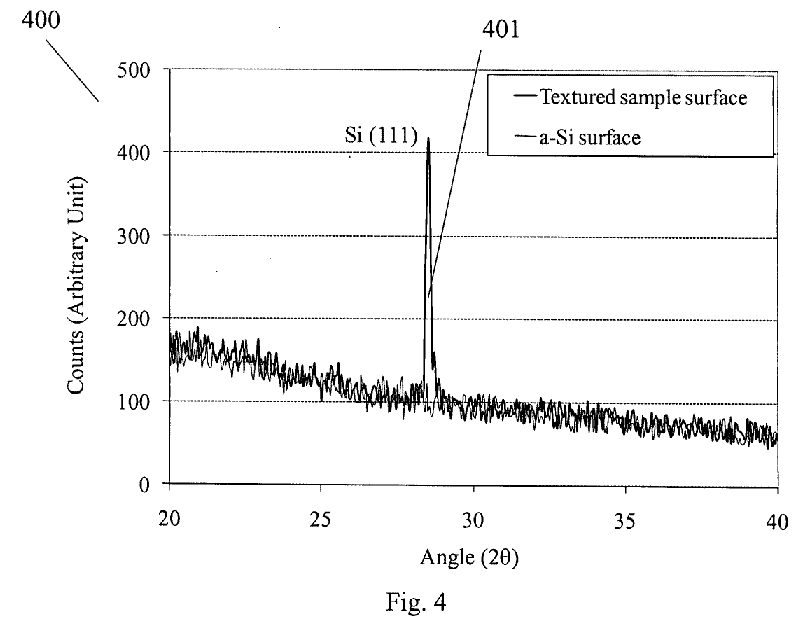

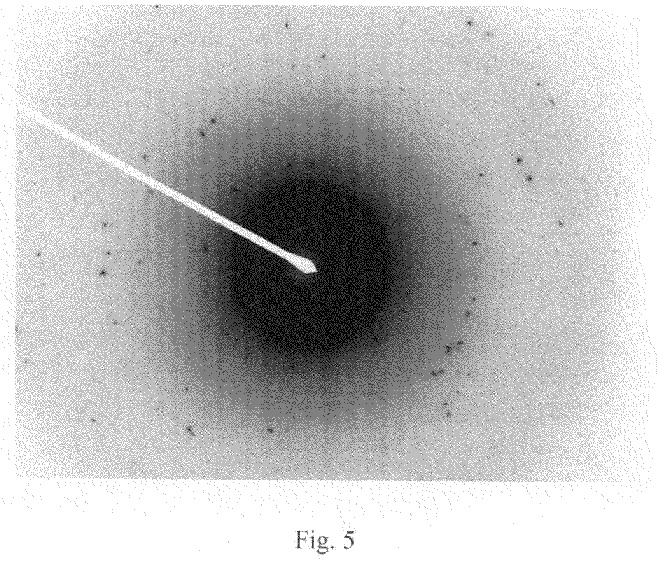

FIG. 2 shows an SEM image of a textured surface 200 produced by the method illustrated in FIG. 1. The bright spots 201 are randomly distributed nano-/micro-silicon crystallites. FIG. 3 is an EDS spectrum taken from the textured surface 200. The spectrum 300 contains a large amount of Si 301 and O 302 but no Al, which indicates that the textures 201 are made of silicon or silicon oxide. FIG. 4 is an XRD spectrum 400 taken from the textured surface 200. The peak 401 around 28.5° reveals that the textured surface 200 is made of silicon (111) crystallites. FIG. 5 is an electron diffraction pattern collected from a silicon crystallite 201 that is detached from the textured surface 200. It further confirms that the textures 201 on the textured surface 200 are silicon (111) crystallites.

### Second Embodiment

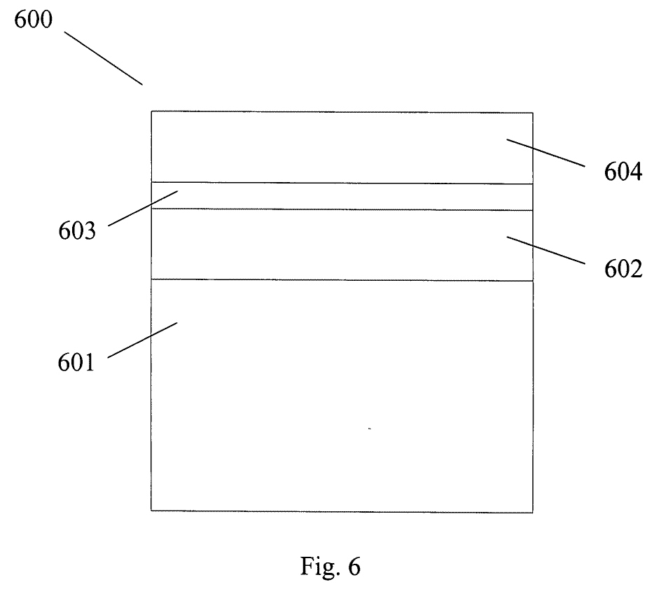

Referring to FIG. 6, a thermal evaporator is used to deposit a layer of Al 602 on a silicon oxide coated silicon (100) wafer 601 to form a sample. After the deposition of Al 602, the sample is removed from the evaporator and exposed to air to form a thin layer of aluminum oxide 603 on top of the Al 602. The sample is then transferred to a PECVD system for the deposition of a layer of a-Si 604 on top of the aluminum oxide 603 to form a multi-layer structure 600. The structure 600 is annealed in air in a conventional furnace. During annealing, some Al diffuses through the a-Si layer 604 to the top surface of the sample 600. After annealing, the Al that passed through the a-Si 604 is removed by wet selective etching, resulting in nano/micro-textured surfaces.

### Third Embodiment

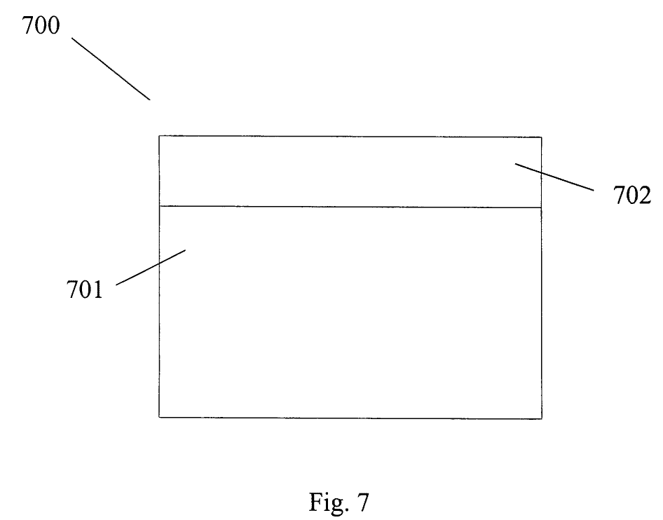

Referring to FIG. 7, using an e-beam evaporator, a layer of a-Si and Al mixture 702 is deposited on a silicon oxide coated silicon (100) wafer 701 to form a sample 700. The sample 700 is annealed in air in a conventional furnace. During annealing, some Al diffuses to the top surface of the sample 700. After annealing, the excessive Al on the top surface of the structure 700 is removed by wet selective etching, resulting in nano/micro-textured surfaces.

In the following examples, various process parameters will be described to illustrate how to use the technique to control the surface wettability and promote cell attachment on a surface in detail. These examples are for illustration purpose only. These specific materials, parameters, and equipment used in the examples are not meant to limit the scope of the invention.

### EXAMPLE 1

This example illustrates how to use the AIRC of a-Si technique according to the present invention to create a superhydrophobic surface.

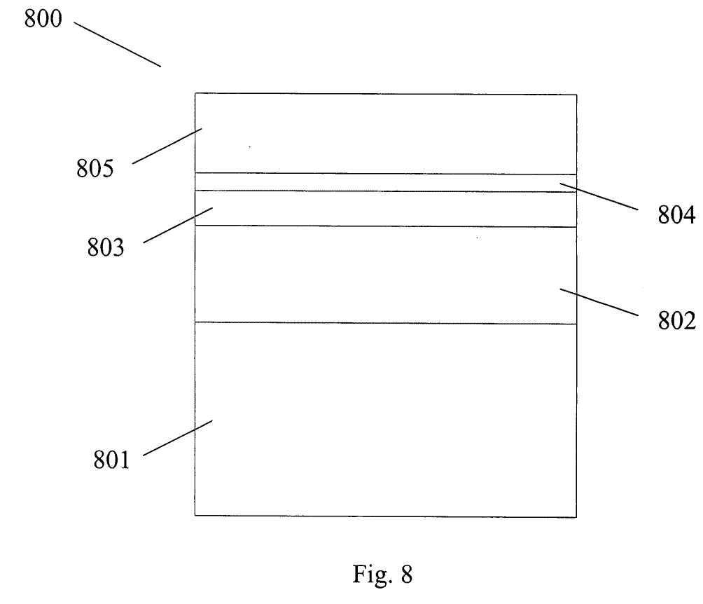

Referring to FIG. 8, one-side polished p-type silicon (100) wafers 801 is selected as a substrate for producing nano/micro-textured surfaces using the AIRC of a-Si technique. The silicon wafer 801 is cleaned by acetone, isopropanol, and deionized water and then wet oxidized at 950° C. for 8 hours to grow a 2 micron-thick silicon oxide film 802. The purpose of growing the thick silicon oxide 802 prior to depositing a-Si 803 is to prevent the crystalline structure of the substrate 801 from affecting the AIRC of a-Si process. The reason for using silicon (100) wafer 801 as a substrate is that silicon (100) wafer 801 is easy to cut for sample preparation in research.

A PECVD system (Plasma-Therm SLR730) is used to deposit an a-Si film 803 of thickness 100 nm on the silicon oxide layer 802 to form a structure consisting of the silicon substrate 801, thermal silicon oxide 802, and a-Si 803. The radio-frequency (RF) power, chamber pressure, substrate temperature, and SiH₄ flow rate are controlled at 20 W, 1 Torr, 250° C., and 85 sccm, respectively. After a-Si 803 deposition, the structure is removed from the PECVD system and exposed to air for three days to form a thin layer of native oxide 804 on top of the a-Si 803. The native oxide 804 increases the consistency and repeatability of the AIRC of a-Si process. An evaporator (Edward's Auto 306) is then used to evaporate an 800 nm-thick Al 805 on the native oxide 804 to form a sample 800.

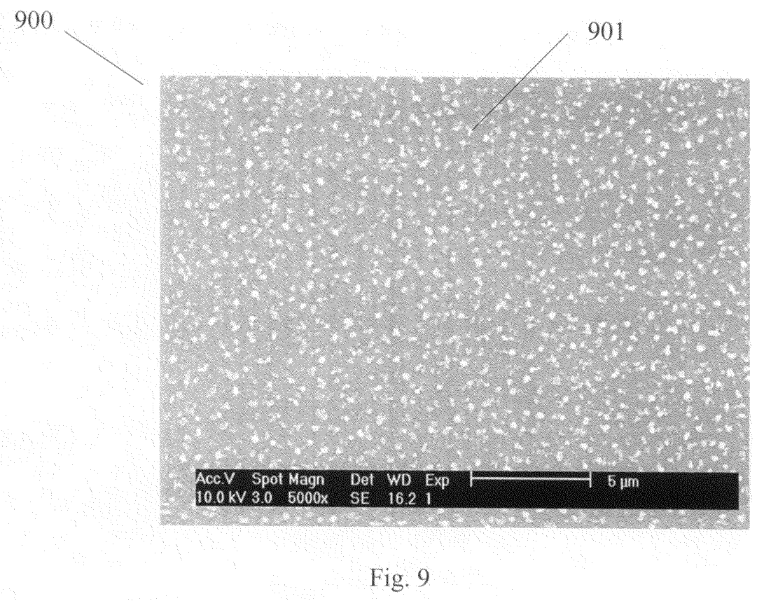

The sample 800 is then annealed in air in a conventional furnace (Lindberg/Blue Box BF51894C) at 850° C. for 5 seconds. After annealing, the excessive Al was removed by immersing the sample 800 in etching solution “Al etchant-type D” (Transene Company, Inc., Danvers, Mass.) for 15 min while maintaining the solution at 50° C., resulting in textured surface 900 with nano/micro-structures as shown in FIG. 9, in which bright spots 901 are nano/micron-sized silicon crystallites.

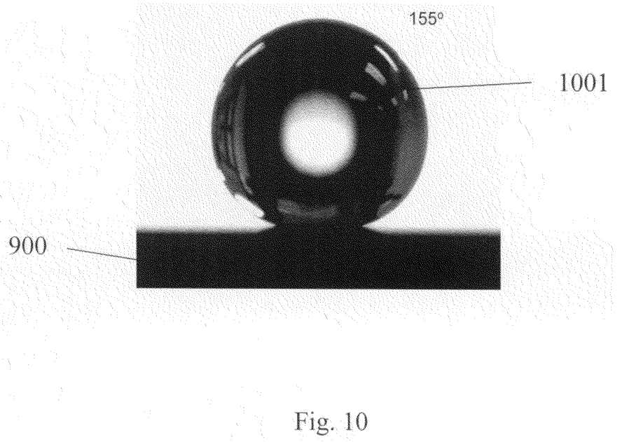

The sample 900 is cleaned by soaking in piranha solution at 20° C. for 1 hour. After piranha cleaning, the sample 900 is rinsed with deionized water and Toluene and blown dried with N₂ gas. The samples were then dipped into an Octadecyltrichlorosilane (OTS)/Toluene solution with an OTS mass concentration of 1% for 10 min to allow the OTS to uniformly self-assemble on the sample surfaces. After the process, the textured surface 900 becomes superphydrobolic with a WCA of 155°. FIG. 10 shows a water droplet 1001 on the OTS coated textured surface 900, in which 1001 is an optical image of a water droplet.

### EXAMPLE 2

This example illustrates how to use the AIRC of a-Si technique according to the present invention to create a superhydrophilic surface.

Referring to FIG. 1, pre-cleaned glass micro slide from VWR International is used as substrate 1101. The substrate 1101 is cleaned in an O₂ plasma asher (LFE APE 110 Plasma system) prior to a-Si deposition. The RF power, chamber pressure, time, and O₂ flow rate were controlled at 250 W, 500 mTorr, 5 min, and 80 sccm, respectively. After cleaning, the substrate 1101 is immediately placed in a PECVD system (Plasma-Therm SLR730) for the deposition of 100 nm-thick a-Si 1102. The RF power, chamber pressure, substrate temperature, and SiH₄ flow rate are controlled at 20 W, 1 Torr, 250° C., and 85 sccm, respectively. The a-Si 1102 coated substrate 1101 is taken out from the PECVD system and left in air for 48 hours at 24° C. in air to grow a thin layer of native oxide 1103 on top of the a-Si 1102. After that, a 670 nm-thick Al film 1104 is deposited on the native oxide 1103 using a thermal evaporator (Edward's Auto 306) to form a sample 1100.

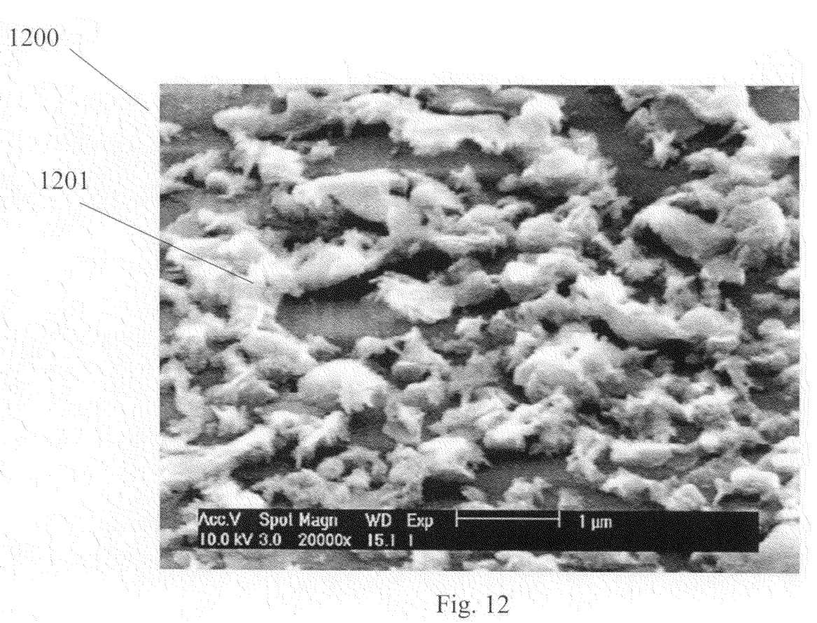

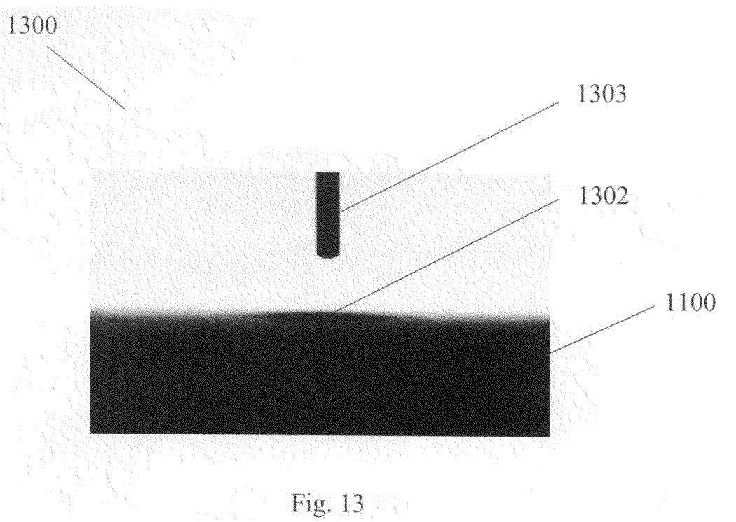

The sample 1100 is annealed at 650° C. for 10 minutes in air using a Lindberg/Blue Box Furnace (Model BF51894C) and then is selectively etched to remove the residual Al in an etching solution “Al etchant—type D” (Transene Company, Inc., Danvers, Mass.) at 50° C. for 5 minutes to form a nano/micro-textured surface 1200 as shown in FIG. 12. FIG. 12 is an SEM image of the textured surface 1200. The white spots 1201 are micro-scaled textures with nano-sized spikes. Such unique structure is critical for a stable superphydrophilic surface. FIG. 13 shows an optical image of a 0.5 μl water droplet 1302 on the textured surface 1200 0.5 seconds after a water droplet drops onto the textured surface 1200 from a needle 1303. FIG. 13 is taken 192 hours after the textured surface 1200 is fabricated. The WAC is still less than 5°, confirming that the textured surface 1200 is superhydrophilic and the superhydrophilicity is stable.

### EXAMPLE 3

This example illustrates how to use the AIRC of a-Si technique according to the present invention to promote cell attachment on a surface.

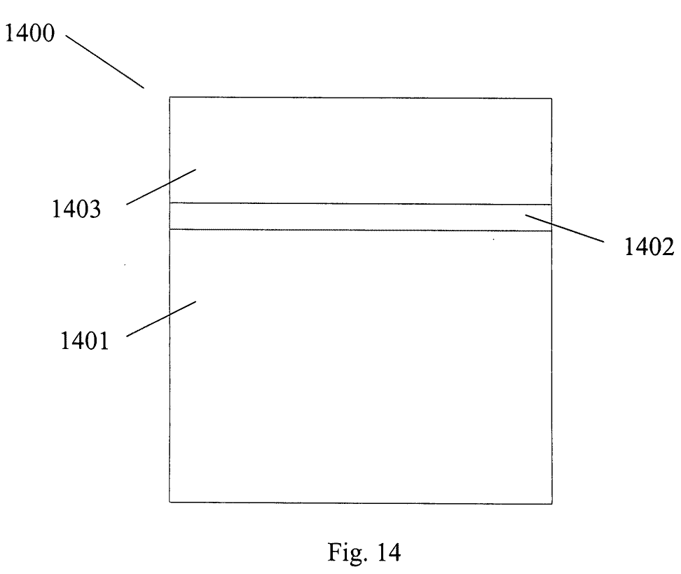

Referring to FIG. 14, pre-cleaned plain glass micro slide from VWR International is selected as a substrate 1401. The substrate 1401 is 76.2 mm long, 25.4 mm wide, and 1.2 mm thick. The primary reason for using glass slides, instead of silicon wafers, is that glass slides is biocompatible and optically transparent, which allows the adhered cells to be characterized using a phase-contrast microscope.

The first step of the process is to use a PECVD system (Plasma-Therm SLR730) to deposit a 10 nm-thick a-Si film 1402 on the glass slide 1401. The PECVD chamber pressure, RF power, substrate temperature, and SiH₄ flow rate are controlled at 0.2 torr, 20 W, 250° C., and 85 sccm, respectively. After a-Si deposition, the a-Si 1402 coated glass slide 1401 is moved into a thermal evaporation system (Edward's Auto 306) for the deposition of an 800 nm-thick Al layer 1403 on top of the a-Si 1402 to form a sample 1400. Next, the sample 1400 is annealed in a furnace (Lindberg/Blue Box BF51894C) at 550° C. for 10 minutes to crystallize the a-Si. Finally, the Al 1403 on sample 1400 is removed by immersing the sample 1400 in an etching solution for 15 minutes while maintaining the solution at 50° C. The etching solution is Al etchant-type D from Transene Company, Inc., Danvers, Mass.

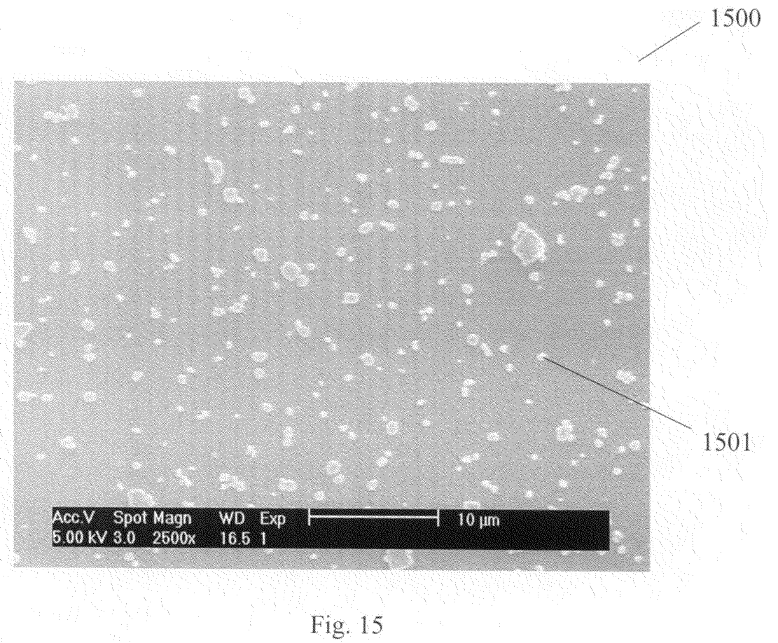

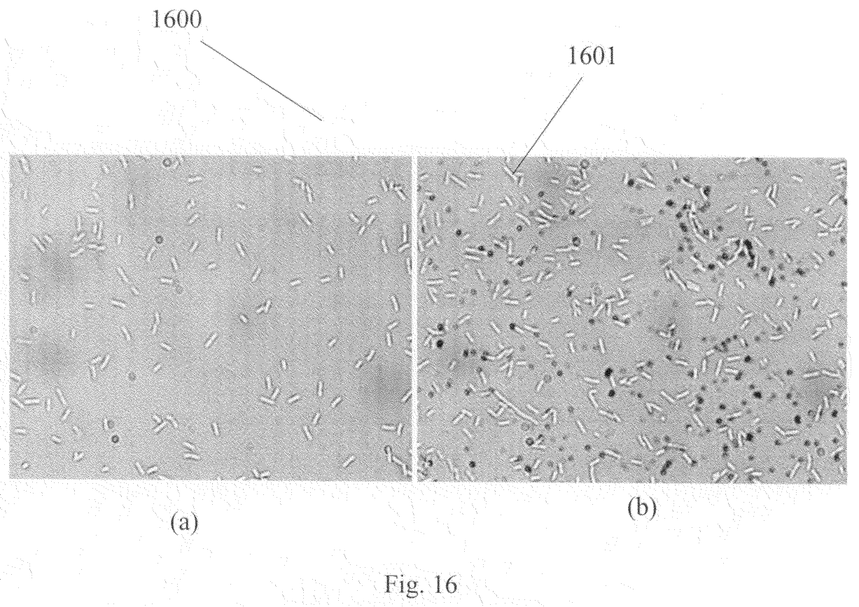

FIG. 15 is an SEM image showing the textured surface 1500 of sample 1400. The white spots 1501 are silicon crystallites. The size of crystallite ranges from nano- to micro-scale. FIG. 16 shows high magnification optical images of live bacteria cells (Escherichia coli KAF95) attached on a non-textured surface and the textured surface 1500. FIG. 16(a) and FIG. 16(b) are the optical images of a non-textured surface and a textured surface 1500, respectively. The white spots 1601 in both FIGS. 16(a) and 16(b) are images of the bacteria cells. Compared with a non-textured surface showing in FIG. 16(a), the textured surface showing in FIG. 16(b) significantly improves cell attachment to a surface. The number of attached cells per unit area on the textured surface 1500 is more than 2 times higher than that on a non-textured surface.

While there have been shown the preferred embodiments and several examples of the present invention, it is to be understood that the specific techniques, materials, parameters, and mechanisms that have been described are merely illustrative of the principles of the invention. Numerous modifications can be made to the method without departing from the scope and spirit of the invention. Furthermore, the embodiments and examples described above and the claims set forth below are only intended to illustrate the principles of the present invention and are not intended to limit the scope of the invention to the disclosed elements.

### LIST OF REFERENCES

[1] Kollias, K., et al., “Production of a Superhydrophilic Surface by Aluminum-induced Crystallization of Amorphous Silicon,” Nanotechnology, Vol. 19, pp. 465304-465309, 2008.
[2] Wang, H., et al., “Adhesion Study of Escherichia coli Cells on Nano-/Micro-textured Surfaces in a Microfluidic System,” IEEE Transactions on Nanotechnology, Vol. 7, No. 5, pp. 573-579, 2008.
[3] Song, Y., et al., “Superhydrophobic Surfaces by Dynamic Nanomasking and Deep Reactive Ion Etching,” Proc. IMechE, Part N: J. Nanoengineering and Nanosystems, Vol. 221, No. 2, pp. 41-48, 2007.
[4] News on Nanotechweb.org (http://nanotechweb.org/cws/article/tech/36785), Nov. 27, 2008.
[5] Feng, L., et al., “Super-hydrophobic surfaces: From natural to artificial,” Advanced materials, Vol. 14, pp. 1857-1860, 2002.
[6] Cao, L. L., et al., “Super water- and oil-repellent surfaces on intrinsically hydrophilic and oleophilic porous silicon films,” Langmuir, Vol. 24, pp. 1640-1643, 2008.
[7] Wu, X. F. et al., “Production and characterization of stable superhydrophobic surfaces based on copper hydroxide nanoneedles mimicking the legs of water striders,” J. Phys. Chem. B, Vol. 110, pp. 11247-11252, 2006.
[8] U.S. Pat. No. 6,197,623, Joo, et al., Mar. 6, 2001.
[9] U.S. Pat. No. 6,339,013, Naseem, et al., Jan. 15, 2002.
[10] Nast, O., et al., “Polycrystalline silicon thin films on glass by aluminum-induced crystallization,” IEEE Transactions on Electron Devices, Vol. 46, No. 10, pp. 2062-2068, 1999.
[11] Wang, H., et al., “Amorphous silicon thickness effect on formation of silicon nanostructures by aluminum-induced crystallization of amorphous silicon,” Electrochemical and Solid-State Letters, Vol. 10, No. 8, pp. H224-H226, 2007.

We claim:

1. A method of making a nano/micro-textured surface for controlling the wettability of a surface and promoting cell attachment and growth on a surface, comprising the steps of:
a. forming an amorphous silicon film on a surface of a substrate;
b. forming a buffer layer on the amorphous silicon film;
c. forming a layer of metal on the buffer layer to form a sample; and
d. applying heat treatment to the sample.

2. The method according to claim 1, further comprising removing the metal layer from the sample after the heat treatment.

3. The method according to claim 1, wherein said substrate comprises a material selected from a silicon wafer, a sheet of glass or quartz, a sheet of metal or alloy, a piece of plastic, a piece of polymer, a piece of ceramic, or mixtures thereof.

4. The method according to claim 1, wherein said buffer layer comprises a material selected from silicon oxide, silicon nitride, oxynitride, or the mixture thereof.

5. The method according to claim 1, wherein said buffer layer having thickness in a range from 0 to 20 micron.

6. The method according to claim 1, wherein said metal comprises a material selected from a group composed of Al, Au, Ag, Co, Cr, Cu, Fe, Ni, Pd, Pt, Ti, Zn or alloy thereof.

7. A method of making a nano/micro-textured surface for controlling the wettability of a surface and promoting cell attachment and growth on a surface, comprising the steps of:
a. forming a metal film on a surface of a substrate;
b. forming a buffer layer on the metal film;
c. forming a layer of amorphous silicon on the buffer layer to form a sample; and
d. applying heat treatment to the sample.

8. The method according to claim 7, further comprising removing the metal that diffuses through the amorphous silicon film to the top surface of the sample during heat treatment.

9. The method according to claim 7, wherein said substrate comprises a material selected from a silicon wafer, a sheet of glass or quartz, a sheet of metal or alloy, a piece of plastic, a piece of polymer, a piece of ceramic, or mixtures thereof.

10. The method according to claim 7, wherein said buffer layer comprises a material selected from aluminum oxide, silicon oxide, silicon nitride, oxynitride, or the mixture thereof.

11. The method according to claim 7, wherein said buffer layer having thickness in a range from 0 to 20 micron.

12. The method according to claim 7, wherein said metal comprises a material selected from a group composed of Al, Au, Ag, Co, Cr, Cu, Fe, Ni, Pd, Pt, Ti, Zn or alloy thereof.

13. A method of making a nano/micro-textured surface for controlling the wettability of a surface and promote cell attachment and growth on a surface, comprising the steps of:
a. forming a layer of metal and amorphous silicon mixture on a surface of a substrate to form a sample; and
b. applying heat treatment to the sample.

14. The method according to claim 13, further comprising removing the metal diffused through the layer of metal and amorphous silicon mixture to the top surface of the sample after heat treatment.

15. The method according to claim 13, wherein said substrate comprises a material selected from a silicon wafer, a sheet of glass or quartz, a sheet of metal or alloy, a piece of plastic, a piece of polymer, a piece of ceramic, or mixtures thereof.

16. The method according to claim 13, wherein said metal comprises a material selected from a group composed of Al, Ni, Fe, Co, Ru, Rh, Pd, Au, Ag, Pt, Ti, Cr, Cu, Zn or alloy thereof.
